(19) United States
(12) Patent Application Publication
(10) Pub. No.: US 2003/0204496 A1
(43) Pub. Date: Oct. 30, 2003

(54) Inter-term relevance analysis for large libraries

(75) Inventors: Sandip Ray, San Francisco, CA (US); Raf M. Podowski, San Mateo, CA (US); Kasian Franks, Novato, CA (US)

Correspondence Address: LAW OFFICES OF JAMES D. IVEY, 3025 TOTTERDELL STREET, OAKLAND, CA, 94611-1742, US

(73) Assignee: X-Mine, Inc.

(21) Appl. No.: 10/135,194

(22) Filed: Apr. 29, 2002

(51) Int. Cl. G06F 7/00

(52) U.S. Cl. 707/3

(57) ABSTRACT

A computer-implemented relevance analyzer extracts content from a technical library and analyzes correlation of inter-term proximity with such content to find terms with strong correlation to a search term. The underlying premise is that two terms, which are found near similar other terms, are likely related to one another. Thus, a strong correlation in proximity relationships of the two terms is a strong indication of likely relation of the two terms.

### FIELD OF THE INVENTION

The invention relates to computer-implemented analysis of textual data and, in particular, a mechanism for analyzing relations between terms in textual data to determine a level of relevance of one term to another.

### BACKGROUND OF THE INVENTION

One area of prolific study is that of relations between various ailments and specific genes of the human genome. The human genome has recently been mapped, and the map of the human genome is widely distributed for all to see. However, while we are able to point to the location of any human gene within the 23 chromosomes that make up the human genome, we still do not know what aspect of human biology each gene affects. Thus, the mapping of the human genome can be thought of as merely the first step in benefitting from understanding the genetic composition of human beings. The second step is determining what effect each gene, or various combinations of genes, have on human biology. Turning that second step on its head, the new quest is to determine what genes affect a particular human ailment.

Extensive research has been, and is being, conducted in the field of genetics and the resulting library of published articles on the topic is quite vast. No one person can even approach familiarity with all research published for an individual topic within genomics in particular and medicine in general.

What is needed is a particularly effective mechanism for assisting researchers in extracting information from libraries which are far too vast for manual reading.

### SUMMARY OF THE INVENTION

In accordance with the present invention, correlation of inter-term relationships are used to find terms of a body of literature to related to a search term. Terms can be word or phrases, for example. In addition, inter-term relationships can be expressed as a degree of proximity between two terms in the literature. Thus, inter-term relationships of the search term can be expressed as a profile of degrees of proximity of the search term to other terms in the body of literature.

Similar profiles are compiled for other terms of the body of literature and those terms whose profiles correlate most closely with the profile of the search term are deemed closely related to the search term and reported as results. The other terms for which such profiles are compiled are collected by (i) determining which terms are generally found in closest proximity to the search term and (ii) determining which other terms are generally found in closest proximity to those terms. Both sets of terms are collected as candidate terms which are evaluated as related to the search term. This two-step process ensures that terms found nowhere near the search term in the literature can be included as candidates.

Searching in the manner described his particularly useful for finding correlations in genetic research. In particular, genetic research is vast and voluminous. Yet, due to the large number of human genes, many interactions between genes have not yet been detected. What searching a library of genetic research papers in the manner described herein enables is the detection of genes which are tied to similar human ailments and/or conditions yet are not yet linked to one another within current research. By detecting similarities in conditions associated with different genes, researchers can begin to research combinations of genes for gene interactions. As a result, simple text mining of research libraries can give researchers important clues as to which genes might operate in concert with one another.

### BRIEF DESCRIPTION OF THE DRAWINGS

FIG. 1 is a block diagram of a relevance analyzer in accordance with the present invention.

FIG. 2 is a logic flow diagram of the behavior of the relevance analyzer of FIG. 1 in searching for correlated terms in accordance with the present invention.

FIGS. 3-7 are logic flow diagrams illustrating steps of FIG. 2 in greater detail.

FIG. 8 is a block diagram showing a knowledge base of FIG. 1 in greater detail.

FIG. 9 is a block diagram showing an inter-term proximity table of FIG. 8 in greater detail.

### DETAILED DESCRIPTION

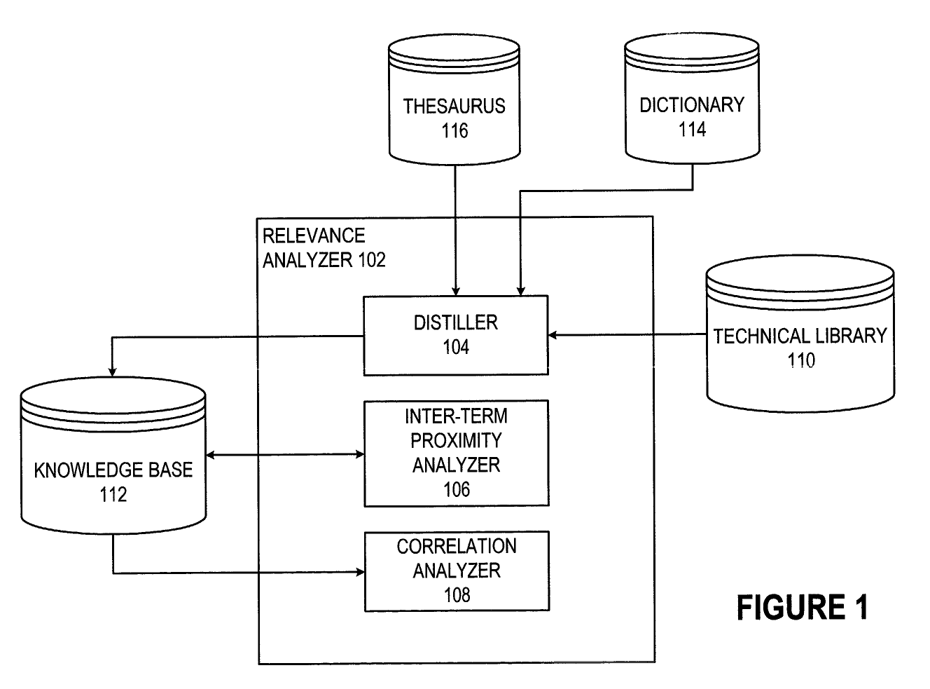

In accordance with the present invention, a computer-implemented relevance analyzer 102 (FIG. 1) extracts content from a technical library 110 and analyzes correlation of inter-term proximity with such content to find terms with strong correlation to a search term. The underlying premise is that two terms, which are found near similar other terms, are likely related to one another. Thus, a strong correlation in proximity relationships of the two terms is a strong indication of likely relation of the two terms. The following example is illustrative.

Consider that, throughout literature in technical library 110, a gene (“gene A” in this example) is related to various types of cancer and such is reflected in high proximity scores between the various names of those types of cancer for gene A. Consider further that the same is true for a second gene (“gene B” in this example). A strong correlation would be detected between the proximity scores for gene A and gene B and such would indicate a strong likelihood that gene A and gene B are related to one another. Perhaps genes A and B act in concert.

One very important advantage of analysis described herein is that detection of the relation between genes A and B does not rely on any indication within the literature itself that genes A and B are related. Such a relation can be entirely unknown and yet still detected in accordance with the present invention. Other advantages include the advantage that results are not biased by individual articles in technical library 110 and that technical library 110 is a reliable source of relationships between terms since well-known relationships are well-documented in technical library 110.

In this illustrative embodiment, relevance analyzer 102 is a computer process—a collection of computer instructions and data which are stored on a storage medium which is readable by a computer and which are executed by one or more computers to perform the tasks described herein. Various aspects of the behavior defined by relevance analyzer 102 are implemented in respective modules which include a distiller 104, an inter-term proximity analyzer 106, and a correlation analyzer 108.

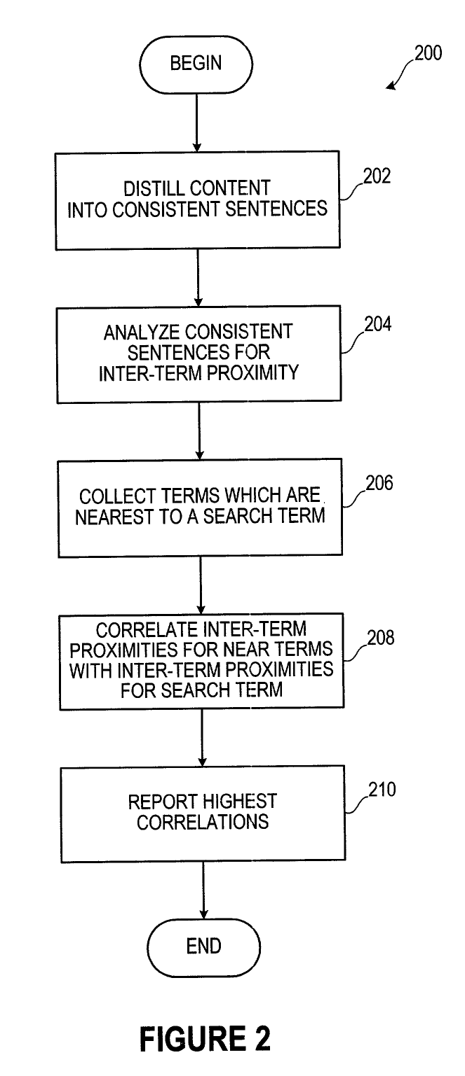

Analysis by relevance analyzer 102 is illustrated by logic flow diagram 200 (FIG. 2).

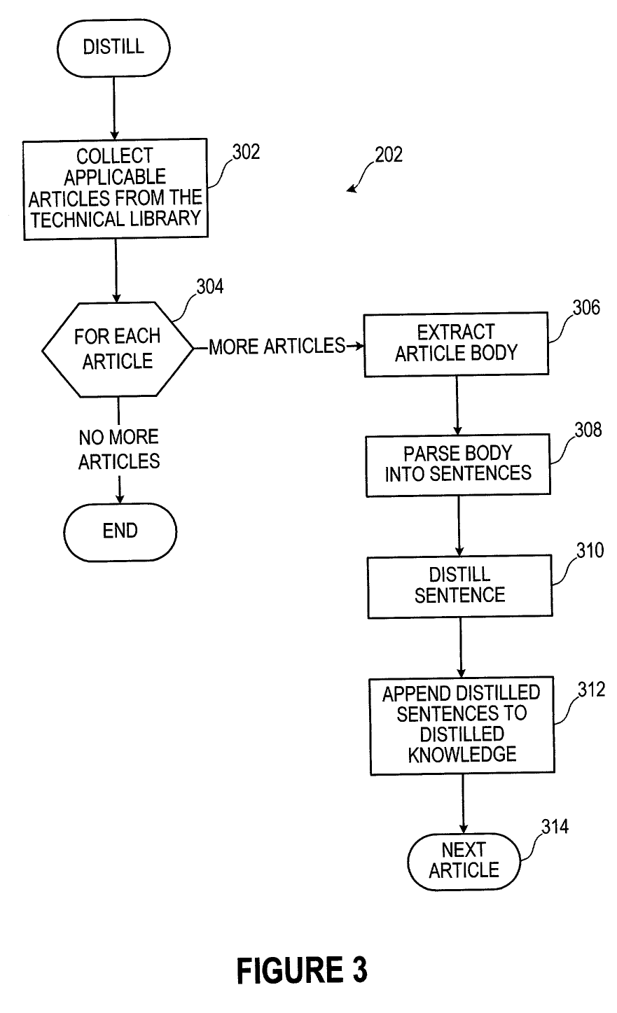

Relevance analyzer 102 (FIG. 1) includes distiller 104 which distills information from technical library 110 to build knowledge base 112. In step 202 (FIG. 2), distiller 104 retrieves content from technical library 110 and distills the content to a consistent form for subsequent analysis. Step 202 is shown in greater detail as logic flow diagram 202 (FIG. 3).

In step 302, distiller 104 (FIG. 1) collects applicable articles from technical library 110. Relevance analyzer 102 can be preprogrammed with a specific set of applicable articles and can provide a user interface by which a user of relevance analyzer 102 can specify which articles of technical library 110 are of interest. Articles can be specified by publication, topic, time and by generally any classification used in conventional electronic publication. In this illustrative example, the research pertains to medical research involving genomics. Accordingly, distiller 104 retrieves all articles pertaining to genomic medical research from technical library 110 in step 302 (FIG. 3).

Loop step 304 and next step 314 define a loop in which distiller 104 performs steps 306-312 for each of the articles retrieved in step 302. During each iteration of the loop of steps 304-314, the particular article processed by distiller 104 is referred to herein as the subject article.

In step 306, distiller 104 extracts the textual body of the subject article. The title, abstract, figures, and other metadata of the subject article are discarded. This prevents the metadata from influencing the results of relevance analysis. By removing the metadata, only substantive content is analyzed for determining relevance of one term to another as described herein.

In step 308, distiller 104 parses the article body into sentences. As described more completely below, the strength of a relation between terms is approximated according to the proximity of the terms to one another. Parsing the article body into sentences ensures that proximity between terms is not measured across multiple sentences. Since sentences are, by grammatical convention anyway, expressions of a single thought, proximity within the single thought is what is measured as an approximation of inter-term relevance. In an alternative embodiment, a different unit of speech, such as a paragraph is used and, in that alternative embodiment, distiller 104 parses article bodies into paragraphs in step 308.

In step 310, distiller 104 distills the sentences parsed in step 308. Specifically, distiller 104 removes extraneous, inconsistent, and incorrect words from each sentence. Extraneous words in this illustrative embodiment include words which are articles (“a,” “an,” and “the” for example), prepositions, and conjunctions. To remove inconsistent use of words, distiller 104 converts plural tense word to singular and replaces synonyms with a single, consistent term such that synonyms as well as plural and singular equivalents match one another and are therefore treated as equivalent terms. Distiller 104 determines singular and plural equivalence by reference to a dictionary 114 and determines synonyms by reference to a thesaurus 116. To remove incorrect words, distiller 104 corrects misspelled words by reference to dictionary 114. It is preferred that misspelled words of a sentence are corrected prior to analyzing the sentence for plural-to-singular conversion and synonym standardization in the manner described above.

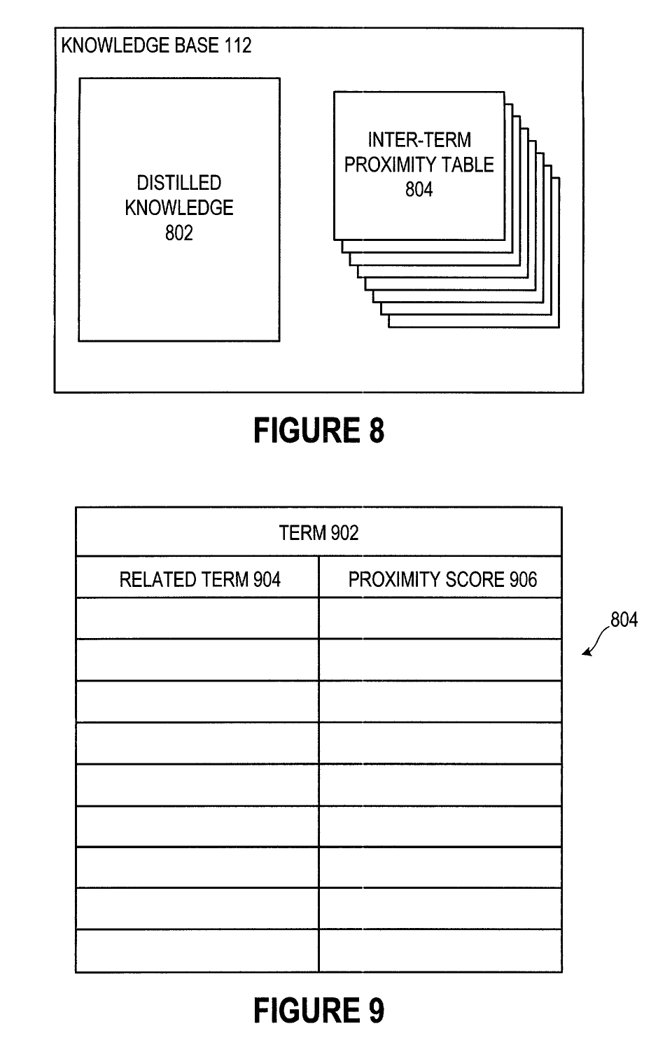

At this point, distiller 104 has reduced the substantive content of the subject article to its essence by omitting metadata, erroneous spellings, and inconsistent use of plural-singular tense and synonyms. Distiller 104 adds the distilled sentences of the subject article to knowledge base 112, in particular, to distilled knowledge 802 (FIG. 8) of knowledge base 112 in step 312 (FIG. 3). In this distilled form, words are referred to herein as terms as some linguistic aspects of the words have been removed.

After step 312, processing by distiller 104 transfers through next step 314 to loop step 304 in which the next article retrieved from technical library 110 is processed according to the loop of steps 304-314 in the manner described above. When all articles have been processed according to the loop of steps 304-314, processing according logic flow diagram 202, and therefore step 202 (FIG. 2), completes.

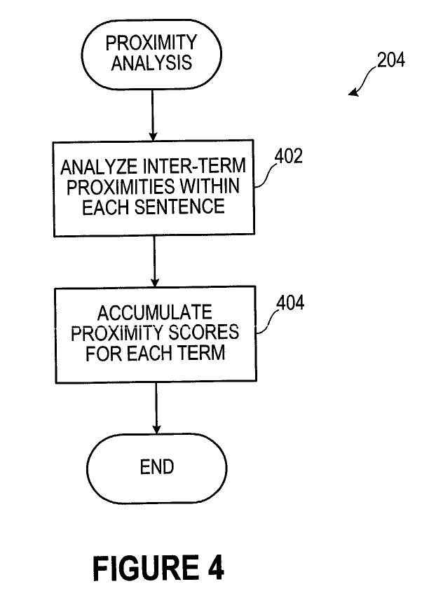

In step 204, inter-term proximity analyzer 106 analyzes knowledge base 112 to determine relative proximity between various terms in the distilled sentences of distilled knowledge 802. Processing by inter-term proximity analyzer 106 in step 204 is shown more completely in logic flow diagram 204 (FIG. 4).

In step 402, inter-term proximity analyzer 106 analyzes inter-term proximity for all terms of each sentence of distilled knowledge 802. In particular, inter-term proximity analyzer 106 quantifies distances between each term of the sentence and each other term. Inter-term proximity is represented in inter-term proximity tables 804 (FIG. 8) of knowledge base 112. Each term found in distilled knowledge 802 is associated with a respective inter-term proximity table 804, an example of which is shown in greater detail in FIG. 9.

Term 902 is the subject term of inter-term proximity table 804. A column of related terms 904 represents terms which appears in distilled sentences of distilled knowledge 802 (FIG. 8) in which term 902 (FIG. 9) also appears. A column of corresponding, respective proximity scores 906 represents respective proximity scores of related terms 904. Proximity scores 906 can be determined such that high scores represent near terms or such that low scores represent near terms. In one embodiment, proximity scores 906 represent average distances between terms as a number of terms. Accordingly, low proximity scores represent near terms while high proximity scores represent terms generally appearing distanced from one another.

In an alternative embodiment, proximity scores 906 are calculated as some predetermined number, e.g., twenty-five, minus the distance between terms as a number of terms and is never less than one if the terms appear in the same language unit, e.g., in the same sentence. Thus, adjacent terms have a proximity score of twenty-four and distant terms which nevertheless appear in the same sentence have a proximity score of one. These proximity scores in this alternative embodiment are accumulated such that the number of times two terms appear near one another influences the overall proximity score for those terms.

While inter-term proximity table 804 is shown as a table, it is appreciated that other known and conventional data structures can be used to represent relative proximity between various terms found in distilled knowledge 802.

In step 404 (FIG. 4), inter-term proximity analyzer 106 accumulates proximity scores for each term such that each term's proximity table 804 represents relations to other terms throughout the entirety of distilled knowledge 802. While analysis and accumulation are shown as separate steps in logic flow diagram 204, accumulation can be performed as sentences are analyzed for inter-term proximity. For example, proximity scores can be summed after each sentence is analyzed. Alternatively, proximity scores can be running averages that are maintained as each sentence is analyzed. What is important is that, at the conclusion of logic flow diagram, each term found in distilled knowledge 802 has an associated inter-term proximity scores for other terms appearing near the term.

After logic flow diagram 204, and therefore step 204 (FIG. 2), correlation analyzer 108 collects terms of knowledge base 112 which are nearest to a search term. It should be noted that, up to those point of the processing by relevance analyzer 102, processing has been independent of any search term. Accordingly, the processing to this point can be performed once and preserved for multiple analyses, involving multiple, different search terms. Alternatively, processing described above can be performed anew for each new search term. This latter approach is generally less efficient but is more certain to include any newly added material of technical library 110.

For continued processing, a search term is provided by the user. The search term is the term for which the user would like to find similarly relevant other terms. Continuing in the illustrate example provided above involving genes A and B, suppose that the user is researching gene A and is interested in other genes which strongly correlate to gene A and may therefore operate in combination with gene A. In this illustrative example, the user provides gene A as the search term using conventional user interface techniques, e.g., by physical manipulation of one or more conventional electronic user input devices.

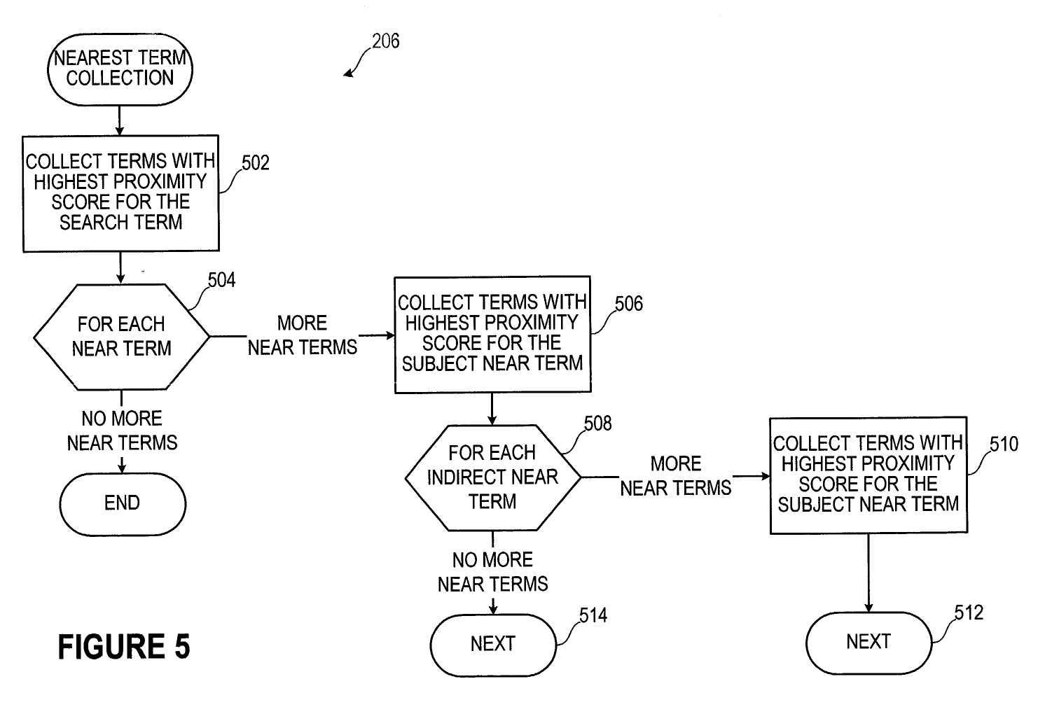

Step 206 is shown in greater detail as logic flow diagram 206 (FIG. 5). In step 502, correlation analyzer 108 collects terms which have the highest proximity scores for the search term. Consider that inter-term proximity table 804 (FIG. 9) represents the search term as indicated in term 902. Correlation analyzer 108 ranks related terms 904 according to proximity scores 804 and selects the related terms with the highest proximity scores. In this illustrative example, high proximity scores indicate a strong inter-term relation. In an alternative embodiment, low proximity scores indicate a strong inter-term relation and correlation analyzer 108 collects related terms with the lowest proximity scores 906. In this illustrative embodiment, correlation analyzer 108 collects the twenty (20) terms most closely related to the search term in step 502. These collected terms are sometimes referred to herein as near terms for convenience.

Loop step 504 and next step 514 define a loop in which correlation analyzer 108 processes each of the near terms according to steps 506-512. During each iteration of the loop of steps 504-514, the near term processed by correlation analyzer 108 is sometimes referred as the subject near term. After processing of all near terms according to the loop of steps 504-514, processing according to logic flow diagram 206 completes.

In step 506, correlation analyzer 108 collects terms which have the highest or lowest proximity scores for the subject near term, whichever indicates a strong inter-term relation with the subject near term. Consider that inter-term proximity table 804 (FIG. 9) represents the subject near term as indicated in term 902. Correlation analyzer 108 ranks related terms 904 according to proximity scores 804 and selects the related terms whose proximity scores indicate the strongest inter-term relation with the subject near term. In this illustrative embodiment, correlation analyzer 108 collects the twenty (20) terms most closely related to the search term in step 502. In an alternative embodiment, correlation analyzer 108 collects the ten (10) terms most closely related to the search term in step 502. These collected terms are sometimes referred to herein as indirectly near terms for convenience.

In steps 502 and 506 (and in step 510 below), correlation analyzer 108 does more than just collected closely related terms. Correlation analyzer 108 also distills inter-term proximity table 804 such that only the most closely related terms are represented in related terms 904 and that related terms 904 are sorted by proximity scores 906. In an embodiment in which steps 202-204 (FIG. 2) are performed once for multiple relevance analyses, correlation analyzer 108 distills copies of inter-term proximity tables 804 such that the original tables are preserved for subsequent searches. The tables are used in a manner described more completely below to determine which of the near terms and indirect near terms are related to terms most similar to the terms to which the search term is related as a measure of relevance to the search term.

Loop step 508 and next step 512 define a loop in which correlation analyzer 108 processes each of the indirect near terms according to step 510. In step 10, correlation analyzer 108 distills an inter-term proximity table 804 for each of the indirect near terms in the manner described above with respect to step 506.

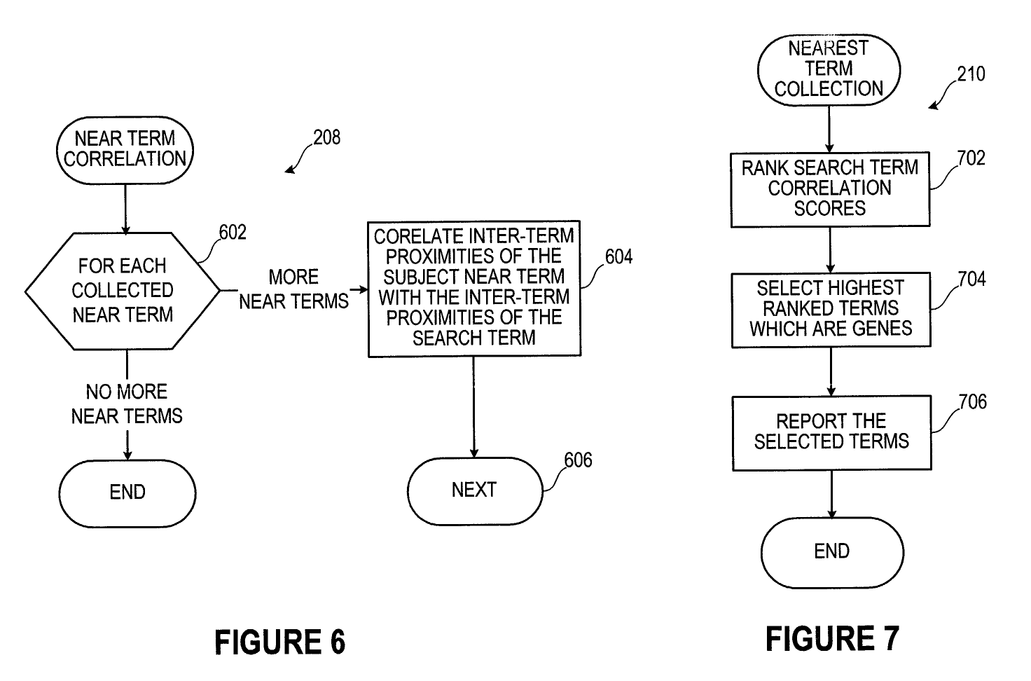

Thus, after completion of logic flow diagram 206, and therefore step 206 (FIG. 2), by correlation analyzer 108, a distilled inter-term proximity table 804 has been created by correlation analyzer 108 (i) for the search term in step 502, (ii) for each near term in step 506, and (iii) for each indirect near term in step 510. In step 208, correlation analyzer 108 correlates the distilled inter-term proximity table for the search term with distilled inter-term proximity tables for the near terms and the indirect near terms. Step 208 is shown more completely as logic flow diagram 208 (FIG. 6).

Loop step 602 and next step 606 define a loop in which correlation analyzer 108 processes each collected near and indirect near term according to step 604. The particular near term, whether a near term or an indirect near term, processed by correlation analyzer 108 in a particular iteration of the loop of steps 602-606 is sometimes referred to herein as the subject near term.

In step 604, correlation analyzer 108 correlates the distilled inter-term proximity table for the subject near term with the distilled inter-term proximity table for the search term. In this illustrative embodiment, correlation analyzer 108 applies a Pearson Product Moment Correlation, which is known and not described further herein, to obtain a correlation score for the subject near term.

The result of processing according to logic flow diagram 206, and therefore step 206 (FIG. 2), is a correlation score relative to the search term for all near terms, whether direct near terms or indirect near terms. The correlation score represents a degree to which the associate near term appears near similar terms to which the search term appears. The two-stage association can be seen as a degree of separation between the search term and the correlated near term. In particular, the score does not represent how closely the search term and near term appear to one another in articles of technical library 110 but instead measures the closeness with which the search term and correlated near term appear to the same other terms. It is this degree of separation, this indirection, which enables detection of correlations between the search term and other terms not directly associated in the literature of technical library 110. Accordingly, relevance analyzer 102 is capable of detecting previously undetected relationships between terms in published literature.

In step 210, correlation analyzer 108 reports the highest correlations to the user. Step 210 is shown in greater detail as logic flow diagram 210 (FIG. 7). In step 702, correlation analyzer 108 ranks the correlation scores determined in step 208 (FIG. 2). In step 704, correlation analyzer 108 selects from the highest ranked terms those which are genes, since relevance analyzer 102 is configured to search specifically for genes in this illustrative embodiment. In step 706, correlation analyzer 108 reports the selected highest ranking gene terms to the user, using conventional computer output techniques.

In reporting the results to the user, relevance analyzer 102 can also include hypertext links or other references to articles within technical library 110 in which highly correlated gene terms are closely related to terms which are closely related to the search term. Relevance analyzer 102 can locate such articles by using conventional text searching techniques using (i) the highly correlated gene term and several of the closely related terms of the highly correlated gene term as article search terms and (ii) the search term and several of the closely related terms of the search term as article search terms. The resulting search of technical library 110 results in articles pertaining to both the search term and the highly correlated gene term and illustrating areas of research in which each of the terms is associated with the same other terms, and therefore associated with similar concepts. Such searching of articles provides a qualitative analysis of the correlation which is already associated with a quantitative score as described above.

The above description is illustrative only and is not limiting. Instead, the present invention is defined solely by the claims which follow and their full range of equivalents.

What is claimed is:

1. A method for finding terms of a body of verbal information which correlate to at least one search term, the method comprising:
(a) determining a degree of relation between the at least one search term and each of one or more other terms of the body of verbal information;
(b) selecting one or more near terms of the other terms according to the degree of relation of each of the other terms;
(c) for each of the near terms:
(i) determining a degree of relation between the near term and each of one or more one or more other terms of the body of verbal information;
(ii) selecting one or more next near terms of the other terms according to degree of relation of each of the other terms;
(d) correlating inter-term relationships of the one or more search terms with inter-term relationships of the near terms and the next near terms; and
(e) selecting the terms of the body of verbal information which correlate to the at least one search term according to results of (d) correlating.
